(19) United States
(12) Patent Application Publication
(10) Pub. No.: US 2015/0267507 A1
(43) Pub. Date: Sep. 24, 2015

(54) Systems and Methods for Downhole Electrical Switching

(71) Applicant: Baker Hughes Incorporated, Houston, TX (US)

(72) Inventors: David S. Bishop, Houston, TX (US); Kirby G. Schrader, Magnolia, TX (US)

(21) Appl. No.: 14/660,216

(22) Filed: Mar. 17, 2015

Related U.S. Application Data
(60) Provisional application No. 61/954,885, filed on Mar. 18, 2014.

(51) Int. Cl. E21B 41/00; E21B 17/00; H01H 47/00

(52) U.S. Cl. CPC E21B 41/00; H01H 47/001; E21B 17/003

(57) ABSTRACT

Systems and methods for alternately coupling equipment at the surface of a well to different ones of a set of downhole tools installed in the well. In one embodiment, a system includes surface equipment positioned at the surface of a well and a plurality of downhole tools that are installed downhole in the well. A switcher is positioned in the well between the surface equipment and the downhole tools. An upper line is electrically connected between the surface equipment and the switcher, and a set of lower lines are electrically connected between the switcher and a corresponding set of of downhole tools. The switcher alternately couples different ones of the lower electrical lines electrically to the upper electrical line. At any time, the upper electrical line is electrically coupled to only one of the lower electrical lines.

### CROSS-REFERENCE TO RELATED APPLICATIONS

This application claims the benefit of U.S. Provisional Patent Application 61/954,885, filed Mar. 18, 2014 by David S. Bishop, et al., which is incorporated by reference as if set forth herein in its entirety.

### BACKGROUND

1. Field of the Invention

The invention relates generally to downhole electric equipment, and more specifically to systems and methods for switching connections between a surface-connected conductor and a plurality of downhole-connected conductors using a switching device that is positioned downhole in a well.

2. Related Art

Increasing numbers of tools, sensors and other equipment are becoming available to use in well completions. The different types of equipment may utilize various types of lines that couple the equipment, which is positioned downhole in the well, to equipment at the surface of the well.

While each of the different types of downhole equipment that may be used in the well is intended to increase the ease and efficiency with which the well is operated, the availability of so many different tools may complicate operation of the well. More specifically, operation of the tools may require that many different lines (e.g., chemical injection lines, fiber optic lines, electric lines, hydraulic lines, etc.) be used to connect the tools to associated equipment at the surface of the well. This can be problematic because there is a limited amount of space that is available for these lines. More specifically, because only a limited number of penetrations can be made through a tubing hanger, only a limited number of lines can be provided through these penetrations to couple downhole tools to the equipment at the surface of the well.

It would therefore be desirable to provide means to increase the number of downhole tools with which surface equipment can communicate, despite a limited number of available penetrations through the tubing hanger. It would also be desirable to provide means to decrease the number of wires or cables that have to be installed between downhole tools and surface equipment to enable communications between them.

### SUMMARY OF THE INVENTION

This disclosure is directed to systems and methods for switching connections between a surface-connected conductor and a set of downhole-connected conductors that solve one or more of the problems discussed above. Embodiments disclosed herein use a switching mechanism (which may be referred to herein as a “switcher”) to alternately connect a single electrical line that is coupled to equipment at the surface of a well to different ones of a set of electrical lines that are coupled to equipment that is installed downhole in the well. By switching the single surface-coupled line to different ones of the downhole-coupled lines, the number of downhole tools with which surface equipment can communicate is increased without increasing the number of penetrations through the tubing hanger. Additionally, this reduces the amount of wire that must be installed in the well to enable communications between the surface equipment and the downhole tools, thereby reducing the cost and weight of the system.

One particular embodiment comprises a switching system for alternately coupling equipment at the surface of a well to different ones of a set of downhole tools installed in the well. The system includes surface equipment positioned at the surface of a well and a plurality of downhole tools that are installed downhole in the well. A switcher is positioned in the well between the surface equipment and the downhole tools. An upper line is electrically connected between the surface equipment and the switcher, and a set of lower lines are electrically connected between the switcher and a corresponding set of downhole tools. The switcher alternately couples different ones of the lower electrical lines electrically to the upper electrical line. At any time, the upper electrical line is electrically coupled to only one of the lower electrical lines.

The switcher may be electrical or mechanical. In one embodiment, a mechanical switcher uses an axially movable contact and a set of stationary contacts that are placed at different axial positions. An electrically conductive rotatable cylindrical sleeve having threads that engage corresponding threads of the axially movable contact may be rotated to move the axially movable contact. The axially movable contact is electrically coupled to the input of the switcher, while each of the stationary contacts is coupled to a corresponding one of the switcher's outputs. The axially movable contact is moved to alternately contact different ones of the stationary contacts, thereby electrically coupling the upper electrical line to a selected one of the lower electrical lines.

Alternative embodiments may include the downhole switching apparatus and methods for using the apparatus to switch the upper electrical line from the surface equipment to different lower electrical lines, thereby enabling communications with different downhole tools using the same upper line.

Numerous additional embodiments are also possible.

### BRIEF DESCRIPTION OF THE DRAWINGS

Other objects and advantages of the invention may become apparent upon reading the following detailed description and upon reference to the accompanying drawings.

FIG. 1 is a functional block diagram illustrating the connections of multiple downhole tools to equipment at the surface of a well.

FIG. 2 is a functional block diagram illustrating the connection of multiple downhole tools to surface equipment through a mechanical switching mechanism in accordance with one embodiment of the invention.

FIG. 3 is a diagram illustrating in more detail an exemplary axial switching mechanism for alternately connecting a first, surface-coupled TEC with one of N downhole-coupled TEC's in accordance with one embodiment.

FIG. 4 is a functional block diagram illustrating the connection of multiple downhole tools to surface equipment through an electrical switching mechanism in accordance with an alternative embodiment of the invention.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims. Further, the drawings may not be to scale, and may exaggerate one or more components in order to facilitate an understanding of the various features described herein.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

Embodiments of the present invention enable the use of an increased number of distinct pieces of downhole electric equipment in a well by providing an easily scalable switching mechanism that can alternately connect an electric line from the surface of the well to any one of a set of distinct lines that are coupled to the different pieces of downhole electric equipment. The switching mechanism can be implemented as either an electrical switcher or a mechanical switcher. The mechanical switcher may be preferred in some instances because it may be difficult to find suitable electrical components to withstand the harsh downhole environment (e.g., temperatures of 300 F or greater), and suitable components may be extremely expensive. The mechanical switcher is preferably axially-oriented to enable the surface-coupled line to be connected to a larger number of downhole-coupled lines than can be achieved using circumferentially-oriented mechanisms.

The various embodiments of the invention may provide a number of advantages over prior art systems and methods. For example, because a single line that is coupled to the surface equipment can be alternately connected to multiple downhole lines, only a single penetration for the surface-coupled line is necessary (as opposed to requiring a penetration for each of the lines coupled to the downhole tools). Further, because there is only a single line that extends from the switcher to the surface equipment (rather than a separate line for each downhole tool), the number of wires in this portion of the well is reduced. This reduces both the weight and the cost of the system.

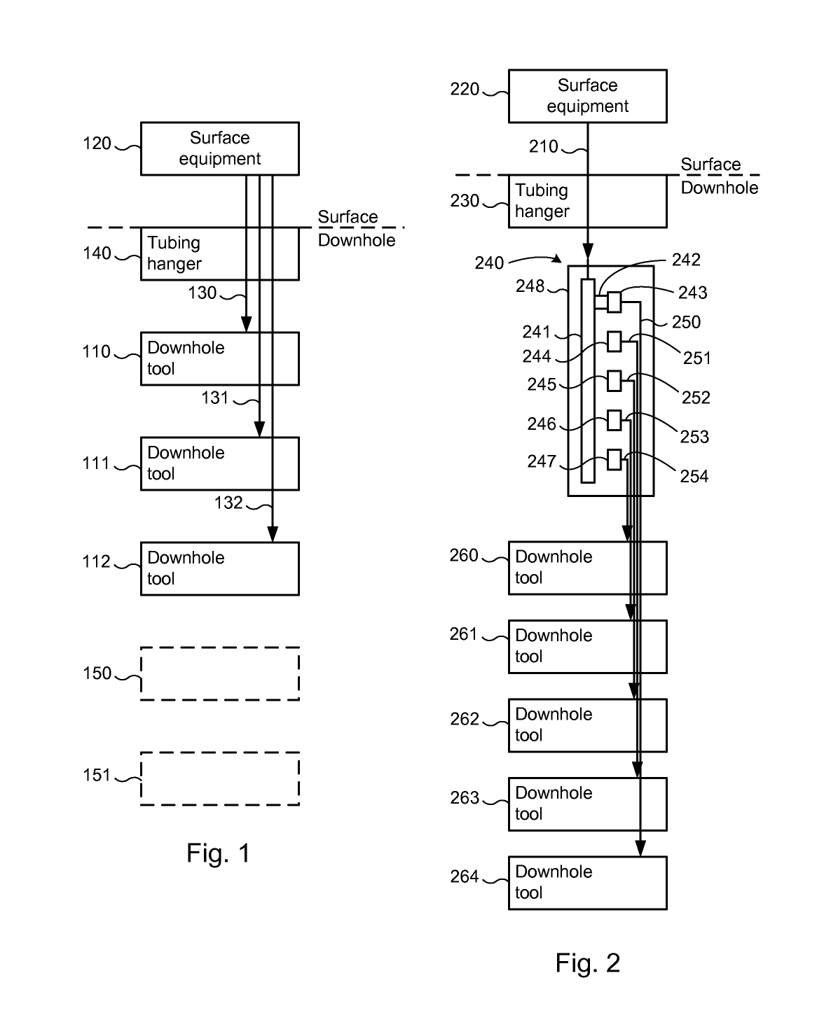

Referring to FIG. 1, a functional block diagram illustrating the connections of multiple downhole tools to equipment at the surface of a well is shown. As depicted in this figure, three downhole tools (110-112) are connected to surface equipment 120 by three corresponding lines (130-132). The lines may, as noted above, include electric, fiber optic, hydraulic or other types of lines. Each line is dedicated to the corresponding downhole tool, and passes from the tool, through tubing hanger 140, to the surface equipment. Because the number of penetrations that can be made through tubing hanger 140 is limited, the number of lines (130-132), and consequently the number tools (110-112) is limited. Thus, if additional tools (e.g., 150-151) were desired, it would not be possible to use them, because it would not be possible to provide additional lines through tubing hanger 140 to surface equipment 120.

Referring to FIG. 2, a functional block diagram illustrating the connection of multiple downhole tools to surface equipment through a switching mechanism in accordance with one embodiment of the invention is shown. In this embodiment, a single electric line 210 extends from surface equipment 220, through tubing hanger 230, to a switching mechanism 240. A set of electric lines 250-254 extend from switching mechanism 240 to tools 260-264.

Within a housing 248 of switching mechanism 240, electric line 210 is connected to a conductive axially extending component 241. An axially movable contact 242 is in electrical contact with axially extending component 241. For the purposes of this disclosure, the term “axial” is used to refer to a direction that is substantially parallel to the axis of the wellbore.

An axially movable contact 242 moves axially along component 241 while maintaining electrical contact with this component. A set of stationary contacts 243-247 are located at axially staggered positions within switching mechanism 240, and each of these contacts is electrically connected to a different one of electric lines 250-254.

Axially movable contact 242 and stationary contacts 243-247 are configured so that the axially movable contact alternately contacts different ones of the stationary contacts as it moves along axially extending component 241. Thus, when axially movable contact 242 is positioned at the upper end of axially extending component 241, it makes electrical contact with stationary contact 243. Electric line 210 is thereby connected through the components of switching mechanism 240 to line 250, so that the downhole tool connected to line 250 can communicate with the surface equipment. When line 250 is connected to the surface equipment, lines 251-254 are disconnected from the surface equipment.

From its upper position where it is in contact with stationary contact 243, axially movable contact 242 can be shifted downward, so that it loses contact with stationary contact 243 and then comes into contact with stationary contact 244. When axially movable contact 242 is in contact with stationary contact 244, surface-coupled line 210 is electrically connected to downhole-coupled line 251, so that communications can be conveyed between surface equipment 220 and tool 261, which is connected to line 251. Similarly, axially movable contact 242 can be shifted downward to contact successive ones of stationary contacts 245-247, thereby alternately enabling electrical communications between surface equipment 220 and downhole tools 262-264, which are connected to lines 252-254.

One of the benefits of the axial shifting mechanism used in this embodiment is that it is easily scalable. In other words, although only five stationary contacts are depicted in FIG. 2, many more can be implemented in alternative embodiments. If it is desired to be able to switch the surface-coupled line to more downhole lines, axially extending component 241 is simply extended, and the number of stationary contacts (243-247) is increased (with one stationary contact per desired downhole line).

By contrast, switching mechanisms that are configured circumferentially can accommodate a limited number of contacts. For the purposes of this disclosure, a circumferentially configured switching mechanism utilizes a movable contact that is rotated to alternately engage different stationary contacts which are arranged at substantially the same axially position, but different circumferential positions around the diameter of the mechanism. Because of the limited diameter in such a mechanism, the scalability of this mechanism is limited. The axially configured switching mechanism, on the other hand, can easily be extended in the axial direction to accommodate more contacts, and is therefore highly scalable.

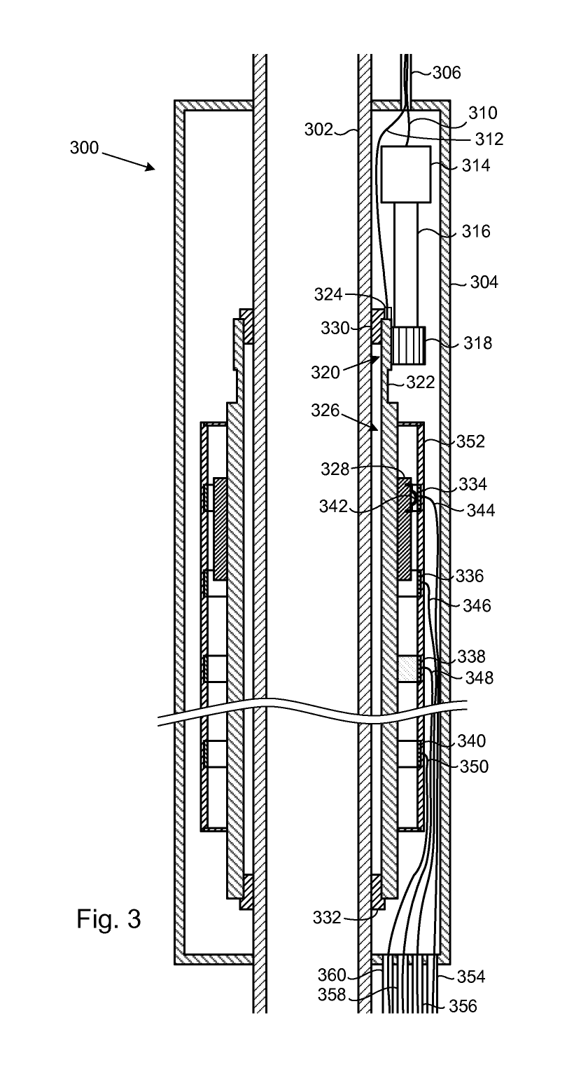

Referring to FIG. 3, a diagram illustrating in more detail an exemplary axial switching mechanism is shown. In this embodiment, a switching apparatus 300 is configured to alternately couple a first TEC from the surface to different ones of a set of downhole TEC's. Using this apparatus, a single conductor in the first TEC can be alternately connected to different downhole TEC's, thereby allowing the surface equipment to communicate with different downhole tools through the different downhole TEC's.

Switching apparatus 300 is designed to be positioned around a length of production tubing 302 within a wellbore. The components of the apparatus may be enclosed between production tubing 302 and a housing 304, or they may be enclosed entirely in a housing through which the production tubing can be inserted. A first TEC 306 that is coupled to the surface equipment is connected to an upper end of housing 304. Each of a set of downhole TEC's (e.g., 354) is connected to a lower end of housing 304.

TEC 306 contains two separate insulated conductors (310, 312). The first of the insulated conductors (310) is connected to a motor 314. Power from conductor 310 drives motor 314 to rotate shaft 316 and driving gear 318. The teeth of driving gear 318 engage corresponding teeth on an upper portion 320 of a driven gear 322. Driven gear 322 forms a cylindrical sleeve that encircles tubing 302. Driven gear 322 is coaxial with tubing 302 and can rotate around the tubing. A pair of non-conductive bearings (330, 332) are positioned between driven gear 322 and tubing 302 to facilitate rotation of the driven gear. The rotation of driven gear 322 is controlled by motor 314 and driving gear 318.

The second of the insulated conductors (312) in TEC 306 is electrically connected to driven gear 322. In this embodiment, a spring contact 324 electrically connects conductor 312 to driven gear 322, allowing conductor 312 to remain stationary while driven gear 322 rotates. Driven gear 322 and axial shifter 328 are both made of conductive material, so that axial shifter remains in electrical contact with the driven gear, regardless of its axial position. It should be noted that shaft 314 and/or driving gear 318 incorporate non-conducting materials to electrically isolate motor 314 from conductor 312.

A lower portion of driven gear 322 is externally threaded. A cylindrical (ring-shaped) axial shifter 328 is positioned around and coaxial with driven gear 322. Axial shifter 328 is internally threaded, and the internal threads of the axial shifter engage the external threads on the lower portion 326 of driven gear 322. Axial shifter 328 is keyed to prevent it from rotating around tubing 302. Consequently, when driven gear 322 rotates around tubing 302, the helical threads on lower portion 326 of the driven gear move non-rotating shifter 328 axially (up or down in the figure). The direction in which axial shifter 328 moves is determined by the direction in which driven gear 322 is rotating. If driven gear 322 rotates in a first direction, axial shifter 328 moves upward. If driven gear 322 rotates in the opposite direction, axial shifter 328 moves downward.

Switching apparatus 300 includes a set of stationary contacts (334, 336, 338, 340). This embodiment, stationary contacts 334, 336, 338 and 340 are conductive rings that have an inner diameter which is slightly larger than the outer diameter of axial shifter 328. Stationary contacts 334, 336, 338 and 340 may be made, for example, of a metal such as brass. Each of the stationary contacts is electrically connected to the insulated conductor (344, 346, 348, 350) of a corresponding downhole TEC. Each of the downhole TEC's is, in turn, connected to a corresponding downhole tool. The stationary contact rings are held in position within the apparatus by a non-conductive support ring 352.

It should be noted that the drawing of the apparatus in FIG. 3 is segmented between stationary contacts 338 and 340. This is intended to indicate the scalability of the apparatus. In other words, the apparatus is not limited to the four stationary contacts explicitly depicted in the figure, but may include any desired number of stationary contacts. The apparatus thereby provides switching of the surface conductor to any of N downhole conductors (where N is an integer variable).

A spring contact 342 is positioned on the outer diameter of axial shifter 328. When axial shifter 328 is positioned with spring contact 342 adjacent to one of the stationary contacts (334, 336, 338, 340), the spring contact maintains electrical contact between the axial shifter and the stationary contact. As driven gear 322 rotates and moves axial shifter 328 up or down within the apparatus, spring contact 342 makes contact with successive ones of the stationary contacts and thereby electrically connects conductor 312 with the corresponding ones of conductors 344, 346, 348 or 350. Axial shifter 328 is only in electrical contact with one of the stationary contacts at a time.

In the embodiment of FIG. 3, the interior of apparatus 300 is filled with a dielectric fluid. The dielectric fluid is hydrostatically balanced to equalize the pressure inside the apparatus with the pressure exterior to housing 304. The dielectric fluid also serves to provide some electrical insulation between the components inside housing 304. Additionally, the use of a fluid such as dielectric oil may provide lubrication of the mechanical components within housing 304.

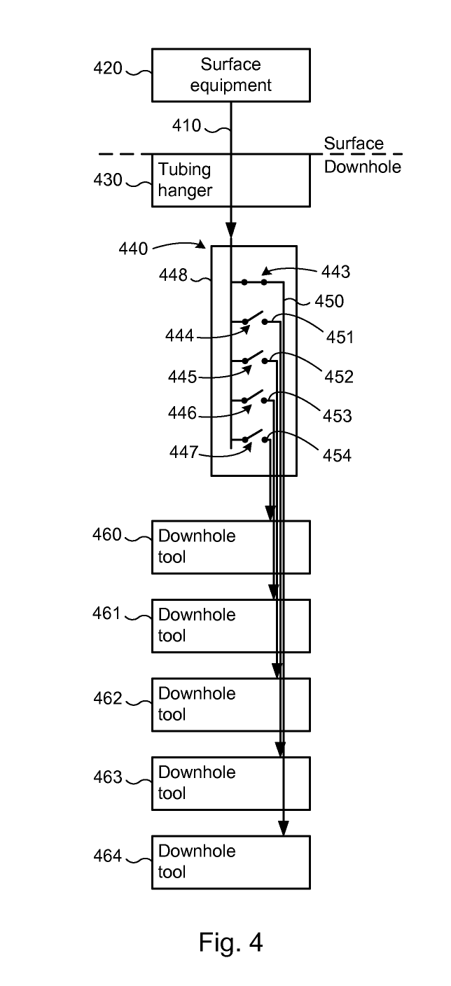

Referring to FIG. 4, a functional block diagram illustrating an alternative embodiment of the invention is shown. In this embodiment, an electrical switching mechanism is used to alternately connect a single electrical line from equipment at the surface of the well to different electrical lines that are coupled to multiple downhole tools. In this embodiment, a single electrical line 410 extends from surface equipment 420, through tubing hanger 430, to a switching mechanism 440. A set of electric lines 450-454 extend from switching mechanism 440 to tools 460-464.

Within a housing 448 of switching mechanism 440, electric line 210 is connected to multiple switches 443-447. These switches selectively connect surface-coupled line 410 to different ones of lines 450-454, each of which is coupled to a different downhole tool. Switches 443-447 are individually controlled so that only one of the switches is closed at a time. As depicted in FIG. 4, switch 443 is closed and switches 444-447 are open. Downhole electrical line 450 is therefore connected to surface line 410, while downhole lines 451-454 are disconnected from the surface line. The surface equipment can therefore communicate through lines 410 and 450 to the particular downhole tool which is coupled to line 450. If it is desired to couple the surface equipment to a different downhole tool, the appropriate one of switches 443-447 is closed, and the remainder of the switches are opened.

One of the benefits of the electrical switcher is that it is relatively simple and easily scalable. As noted above, however, electrical components that can withstand the harsh environments downhole in the well are very expensive and are not as robust as the mechanical switcher. This mechanism may therefore be impractical to implement.

It should be noted that there may be a number of variations of the above components in alternative embodiments. For example, although the embodiment of FIG. 3 uses a motor to rotate conductive driven gear 322 and thereby move shifter 328 axially, alternative embodiments could use other means to shift the movable contact. One possible means would be a hydraulically actuated shifter. The motor of FIG. 3 may be preferable, however, because it can be controlled via a second conductor in the surface-coupled TEC, where a hydraulic actuator may require a separate hydraulic line from the surface which would necessitate another penetration through the tubing hanger. Similarly, the rotating sleeve mechanism could be replaced by another means to shift the axially movable contact, such as a smaller threaded rod which could be threaded through the axial shifter, so that rotation of the rod would move the shifter axially.

The configurations of the contacts and electrically conducting components may also vary in other embodiments. The stationary contacts need not be rings, but could instead have a limited angular extent. The contacts may also be configured to provide simultaneous 1:N switching of multiple parallel conductors, rather than a single conductor (e.g., a pair of conductors from the surface could be switched to alternate pairs of downhole conductors). Further variations may also be apparent to those of skill in the field of the invention.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the described embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the descriptions herein.

What is claimed is:

1. A switching system for alternately coupling equipment at the surface of a well to different ones of a set of downhole tools installed in the well, the system comprising:
surface equipment positioned at the surface of a well;
a plurality of downhole tools installed downhole in the well;
a switcher positioned in the well between the surface equipment and the plurality of downhole tools;
an upper electrical line electrically connected between the surface equipment and the switcher; and
a plurality of lower electrical lines, wherein each of the lower electrical lines is electrically connected between the switcher and a corresponding one of the plurality of downhole tools;
wherein the switcher alternately couples different ones of the lower electrical lines electrically to the upper electrical line, and wherein at any time, the upper electrical line is electrically coupled to only one of the plurality of lower electrical lines.

2. The system of claim 1, wherein the switcher comprises a mechanical switcher having an axially movable contact and a plurality of stationary contacts, wherein the axially movable contact is electrically coupled to the input of the switcher and each of the plurality of stationary contacts is coupled to a corresponding one of the plurality of outputs of the switcher, wherein the axially movable contact is movable to alternately contact different ones of the plurality of stationary contacts, wherein at any time, the axially movable contact is in contact with only one of the plurality of stationary contacts.

3. The system of claim 2, wherein the switcher further comprises an electrically conductive rotatable cylindrical sleeve, the cylindrical sleeve having threads that engage corresponding threads of the axially movable contact, wherein rotation of the cylindrical sleeve causes the axially movable contact to move in an axial direction, and wherein when the axially movable contact is in contact with a selected one of the stationary contacts, the selected one of the stationary contacts is electrically coupled to the input through the cylindrical sleeve.

4. The system of claim 2, wherein the switcher comprises: a housing; an input configured to be coupled to the upper electrical line; a plurality of outputs, wherein each of the plurality of outputs is configured to be coupled to a corresponding one of the plurality of lower electrical lines; wherein the mechanical switcher selectively electrically couples different ones of the outputs to the input and thereby different ones of the lower electrical lines electrically to the upper electrical line.

5. The system of claim 1, wherein the upper electrical line comprises a tubing encapsulated conductor.

6. The system of claim 5, wherein the plurality of lower electrical lines comprise tubing encapsulated conductors.

7. The system of claim 1, wherein the switcher comprises an electrical switcher that includes a plurality of switches, wherein each of the switches is connected between the input and a corresponding one of the plurality of outputs, wherein circuitry within the electrical switcher controls the switches to cause a selectable one of the switches to close while the remaining switches are open, thereby causing a single selected one of the outputs to be electrically coupled to the input.

8. The system of claim 7, wherein the electrical components of the switcher comprise high-temperature components that are capable of operating in a downhole environment in which a temperature exceeds 300 F.

9. The system of claim 8, further comprising a tubing hanger, wherein the upper electrical line makes a single penetration through tubing hanger, and wherein electrical communications are alternately established with different ones of the plurality of downhole tools through the single penetration.

10. A downhole switching apparatus comprising:
a housing configured to be positioned downhole in a well;
an input configured to be coupled to an upper electrical line;
a plurality of outputs, wherein each of the plurality of outputs is configured to be coupled to a corresponding one of a plurality of lower electrical lines; and
a switcher within the housing, wherein the switcher selectively electrically couples different ones of the outputs to the input, and wherein at any time, the input is electrically coupled to only one of the plurality of outputs.

11. The apparatus of claim 10, wherein the switcher comprises an electrical switcher that includes a plurality of switches, wherein each of the switches is connected between the input and a corresponding one of the plurality of outputs, wherein circuitry within the electrical switcher controls the switches to cause a selectable one of the switches to close while the remaining switches are open, thereby causing a single selected one of the outputs to be electrically coupled to the input.

12. The apparatus of claim 11, wherein the electrical components of the switcher comprise high-temperature components that are capable of operating in a downhole environment in which a temperature exceeds 300 F.

13. The apparatus of claim 10, wherein the switcher comprises a mechanical switcher having an axially movable contact and a plurality of stationary contacts, wherein the axially movable contact is electrically coupled to the input of the switcher and each of the plurality of stationary contacts is coupled to a corresponding one of the plurality of outputs of the switcher, wherein the axially movable contact is movable to alternately contact different ones of the plurality of stationary contacts, wherein at any time, the axially movable contact is in contact with only one of the plurality of stationary contacts.

14. The apparatus of claim 13, wherein the switcher further comprises an electrically conductive rotatable cylindrical sleeve within the housing, the cylindrical sleeve having threads that engage corresponding threads of the axially movable contact, wherein rotation of the cylindrical sleeve causes the axially movable contact to move in an axial direction, and wherein when the axially movable contact is in contact with a selected one of the stationary contacts, the selected one of the stationary contacts is electrically coupled to the input through the cylindrical sleeve.

15. A method for alternately coupling equipment at the surface of a well to different ones of a set of downhole tools installed in the well, the method comprising:
installing surface equipment at the surface of a well;
installing a plurality of downhole tools installed downhole in the well;
installing a switcher in the well between the surface equipment and the plurality of downhole tools;
installing an upper electrical line electrically connected between the surface equipment and the switcher;
installing a plurality of lower electrical lines, wherein each of the lower electrical lines is electrically connected between the switcher and a corresponding one of the plurality of downhole tools; and
controlling the switcher and thereby alternately coupling different ones of the lower electrical lines electrically to the upper electrical line, wherein at any time, the upper electrical line is electrically coupled to only one of the plurality of lower electrical lines.

16. The method of claim 15, wherein controlling the switcher comprises moving an axially movable contact to alternately contact different ones of a plurality of stationary contacts, wherein the axially movable contact electrically couples the upper electrical line to the ones of the plurality of lower electrical lines that is connected to the one of the stationary contacts contacted by the axially movable contact.

17. The method of claim 16, wherein moving the axially movable contact comprises rotating an electrically conductive rotatable cylindrical sleeve which is in electrical contact with the axially movable contact, the cylindrical sleeve having threads that engage corresponding threads of the axially movable contact, wherein rotation of the cylindrical sleeve causes the axially movable contact to move in an axial direction.
